(19) United States
(12) Patent Application Publication
(10) Pub. No.: US 2005/0189386 A1
(43) Pub. Date: Sep. 1, 2005

(54) Front mounted baby carrier

(76) Inventor: Michelle Mortell, Malibu, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 10/787,719

(22) Filed: Feb. 26, 2004

(51) Int. Cl. A61G 1/00

(52) U.S. Cl. 224/160

(57) ABSTRACT

A front mounted baby carrier includes a support element having front and rear support elements. These support elements narrow toward their lower ends and are joined together with a restraining strap to form a crotch support for a baby. The restraining straps are joined together with adjustable buckles for babies at different stages of development. The upper portion of the front support element includes a pair of arm holes to support the baby's arms. This upper portion may be folded outwardly to provide an armrest for a larger baby. The support element may be padded and covered in waterproof material. The shoulder straps of the carrier include a sliding fixture to prevent tangling of the shoulder straps. Sliding shoulder pads are attached to the straps. As the shoulder straps are not removable, the carrier is easy for a wearer to put on with or without a baby in the carrier.

### FIELD OF INVENTION

The invention pertains to devices for manually transporting babies and infants. More particularly, the invention relates to front mounted baby carriers designed to be worn as a vest or pack.

### BACKGROUND OF THE INVENTION

As most babies are not ambulatory for as much as a year or more, there is a need to carry them when moving from place to place. Various devices have been developed to relieve the strain on a person's back and arms for the considerable amount of carrying required. Problems exist with many of these devices in that they are heavy, uncomfortable to wear or use, complex to assemble or difficult to get the baby into and out of. Many of these devices require a variety of adjustments to be useful and these adjustments tend to lose their settings when the carrier is removed and stored or transported. It is often difficult for a person attempting to get a baby into a carrier to also deal with properly connecting and adjusting the carrier at the same time. A carrier that stayed in proper adjustment when removed would be both easier and simpler to use.

U.S. Pat. No. 4,903,873 issued to Poole et al. is directed to an infant carrier for use in an aqueous environment. The invention describes an infant carrier including a harness and a pouch that is designed for use in pools, etc. The device is made of a suitable strong, quick-dry, soft flexible textile webbing material however it employs a complex series of connectors, a belt and harness members.

U.S. Pat. No. 6,433,339 issued to Higuchi is directed to a baby carrier used for holding a baby in both face-to-face and forward-facing manners. U.S. Pat. No. 6,520,391 issued to Yen is directed to a baby shoulder cradle having a waist strap. U.S. Pat. No. 5,632,425 issued to Hull patent is directed to an infant carrier is designed to carry the infant in a forward-facing direction on the front portion of the torso of the carrying individual.

U.S. Pat. No. 6,325,023 issued to Elnatan discloses a method and apparatus for assisting a child to walk. This patent describes a harness designed to be used on the front of an individual with a child or other smaller person within a harness facing forward such that the individual may receive assistance in learning to walk. The apparatus may be used in a swimming pool environment, etc.

It is an objective of the present invention to provide a baby or infant carrier that is easily and comfortably worn by an individual. It is a further objective to provide a carrier that is always assembled for immediate use. It is a still further objective of the invention to provide a carrier that is easy for an individual to put on and that it is easy to insert a baby into. It is yet a further objective to provide a carrier that is suitable for use in an aqueous environment. Finally, it is an objective of the invention to provide a baby carrier that can be easily and inexpensively manufactured.

While some of the objectives of the present invention are disclosed in the prior art, none of the inventions found include all of the requirements identified.

### SUMMARY OF THE INVENTION

The present invention addresses all of the deficiencies of prior front mounted baby carrier inventions and satisfies all of the objectives described above.

(1) A front mounted baby carrier providing the desired features may be constructed from the following components. A support element is provided. The support element has a front support portion and a rear support portion. The front support portion has a first side edge and a second side edge. The rear support portion has a first side edge and a second side edge. Means are provided for attaching the first side edge of the front support portion to the first side edge of the rear support portion at at least one point adjacent each of the first side edges. Means are provided for attaching the second side edge of the front support portion to the second side edge of the rear support portion at at least one point adjacent each of the second side edges. At least one shoulder strap is provided. The shoulder strap is attached to the rear support portion.

When the shoulder strap is placed over a shoulder of a wearer and an infant is placed between the front support portion and the rear support portion, facing outwardly toward the front support portion, the infant is secured within the carrier on a chest of the wearer by attaching the means for attaching the first side edge of the front support portion to the first side edge of the rear support portion and the means for attaching the second side edge of the front support portion to the second side edge of the rear support portion.

(2) In a variant of the invention, the support element is formed of waterproof material, making the carrier usable in an aqueous environment.

(3) In a further variant of the invention, the support element is padded.

(4) In still a further variant, the front support portion of the support element further includes first and second arm openings. The arm openings are located in an upper section of the front support portion adjacent the first and second side edges of the front portion. The upper section is foldable adjacent the first and second arm openings to allow formation of an armrest to accommodate an increase in arm size as an infant grows.

(5) In another variant of the invention, the front support portion and the rear support portion narrow toward lower ends of the portions to form a crotch support to accommodate legs of an infant.

(6) In still another variant, the means for attaching the first and second side edges of the front support portion to the first and second side edges of the rear support portion at at least one point adjacent each of the first and second side edges includes at least one restraining strap. The restraining strap has a first section and a second section. The first section is attached to the front support portion at right angles to a long axis of the front support portion, and extends outwardly from the first and second side edges of the front support portion. The second section is attached to the rear support portion at right angles to a long axis of the rear support portion, and extends outwardly from the first and second side edges of the rear support portion. First and second adjustable attaching buckle ends are provided. The attaching buckle ends are slidably and adjustably affixed at first and second ends of the second section of the restraining strap. First and second receiving buckle ends are provided. The receiving buckle ends are slidably and adjustably affixed at first and second ends of the first section of the restraining strap. When the adjustable attaching buckle ends are attached to the receiving buckle ends, an opening between the front support portion and the rear support portion of the support element is adjustable to fit snugly about a torso of the infant.

(7) In yet another variant, the upper section of the front support portion is removably attached to the at least one shoulder strap adjacent the first and second side edges of the front support portion above the first and second arm openings.

(8) In a further variant, the upper section of the front support portion is removably and adjustably attached to the at least one shoulder strap with adjustable attaching buckle ends. The buckle ends are slidably and adjustably affixed to a second strap section attached to the upper section of the front support portion. Receiving buckle ends are affixed to a first strap section attached to the at least one shoulder strap.

(9) In another variant of the invention, the at least one shoulder strap includes a first shoulder portion. The first shoulder portion is sized and shaped to be worn on the first shoulder of a wearer. A second shoulder portion is provided. The second shoulder portion is sized and shaped to be worn on a second shoulder of a wearer. The first and second shoulder portions cross one another at a back of the wearer. A sliding fixture is provided. The sliding fixture provides passageways through which the first and second shoulder portions are routed to prevent tangling of the shoulder portions.

(10) In still another variant, the sliding fixture includes a front plate and a rear plate. Each of the plates has an inner surface and an outer surface. The plates are joined to one another at four points spaced from each other on the inner surfaces. The spacing is sufficient to accommodate a width of the first and second shoulder portions. When the shoulder portions of the at least one shoulder strap are threaded through the passageways of the sliding fixture, the shoulder portions are easily put over the shoulders of a wearer without tangling.

(11) In yet another variant, a reclosable pocket is provided. The pocket is located upon the front support portion of the support element. The pocket is reclosable with a flap of the pocket that has either a hooking element or a looping element attached to it and either a mating hooking element or a mating looping element attached to a front portion of the pocket.

(12) In a final variant, the at least one shoulder strap includes at least one shoulder pad. The shoulder pad is slidably attached to the at least one shoulder strap.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of the preferred embodiment of the invention illustrating the front and rear support portions and shoulder straps;

FIG. 2 is a side elevation of the FIG. 1 embodiment illustrating the front and rear support portions attached together and the carrier attached to a wearer;

FIG. 3 is a rear elevation of the FIG. 1 embodiment illustrating the shoulder straps and sliding fixture;

FIG. 3A is a perspective detail view of the sliding fixture;

FIG. 4 is a plan view of the FIG. 1 embodiment illustrating the crotch support and the front support portion in an upper position; and

FIG. 5 is a front elevation of the FIG. 1 embodiment with the front support portion in a lower position to form an armrest, also illustrating the pocket; and

### DETAILED DESCRIPTION OF THE PREFERRED EMBODIMENT

The present invention addresses all of the deficiencies of prior front mounted baby carrier inventions and satisfies all of the objectives described above.

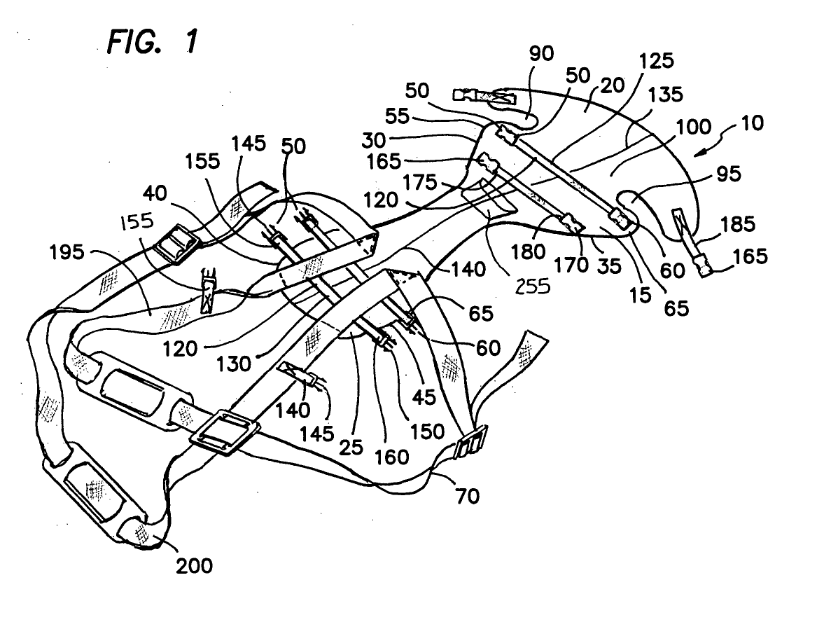

(1) FIGS. 1-5 illustrate a front mounted baby carrier 10 providing the desired features that may be constructed from the following components. As illustrated in FIG. 1, a support element 15 is provided. The support element 15 has a front support portion 20 and a rear support portion 25. The front support portion 20 has a first side edge 30 and a second side edge 35. The rear support portion 25 has a first side edge 40 and a second side edge 45. Means 50 are provided for attaching the first side edge 30 of the front support portion 20 to the first side edge 40 of the rear support portion 25 at at least one point 55 adjacent each of the first side edges 30, 40. Means 60 are provided for attaching the second side edge 35 of the front support portion 20 to the second side edge 45 of the rear support portion 25 at at least one point 65 adjacent each of the second side edges 35, 45. At least one shoulder strap 70 is provided. The shoulder strap 70 is attached to the rear support portion 25.

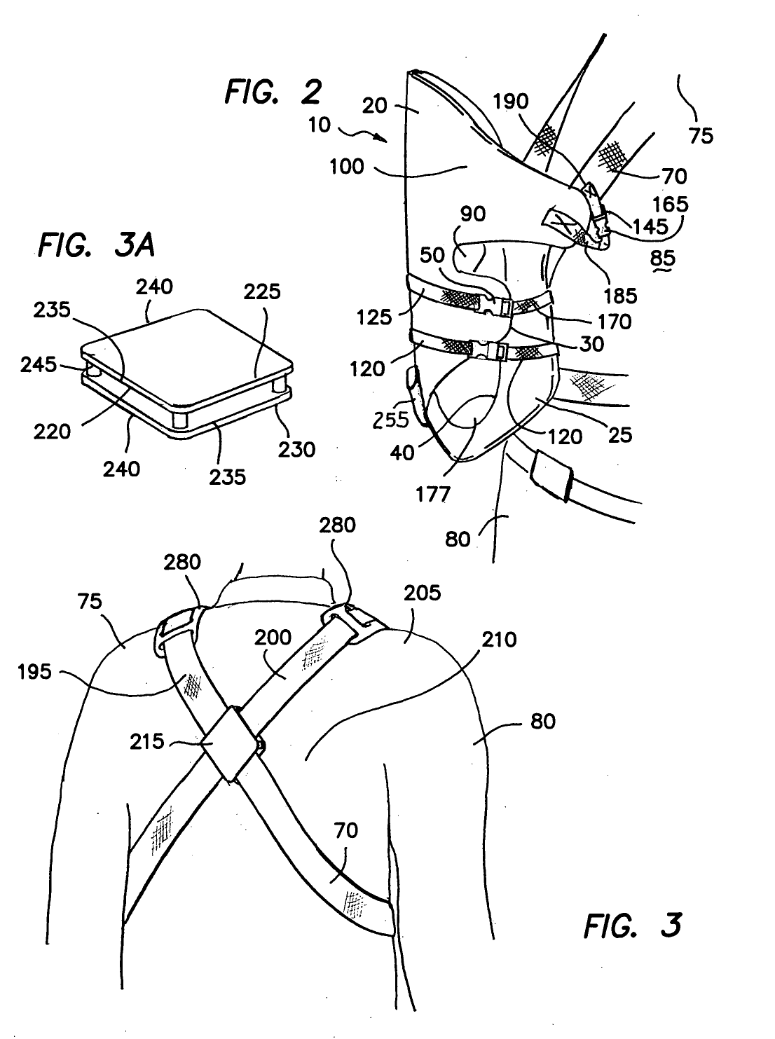

As illustrated in FIG. 2, when the shoulder strap 70 is placed over a shoulder 75 of a wearer 80 and an infant (not shown) is placed between the front support portion 20 and the rear support portion 25, facing outwardly toward the front support portion 20, the infant is secured within the carrier 10 on a chest 85 of the wearer 80 by attaching the means 50 for attaching the first side edge 30 of the front support portion 20 to the first side edge 40 of the rear support portion 25 and the means 60 for attaching the second side edge 35 of the front support portion 20 to the second side edge 45 of the rear support portion 25.

(2) In a variant of the invention, the support element 15 is formed of waterproof material, making the carrier 10 usable in an aqueous environment (not shown).

(3) In a further variant of the invention, as illustrated in FIGS. 2, 4 and 5, the support element 15 is padded.

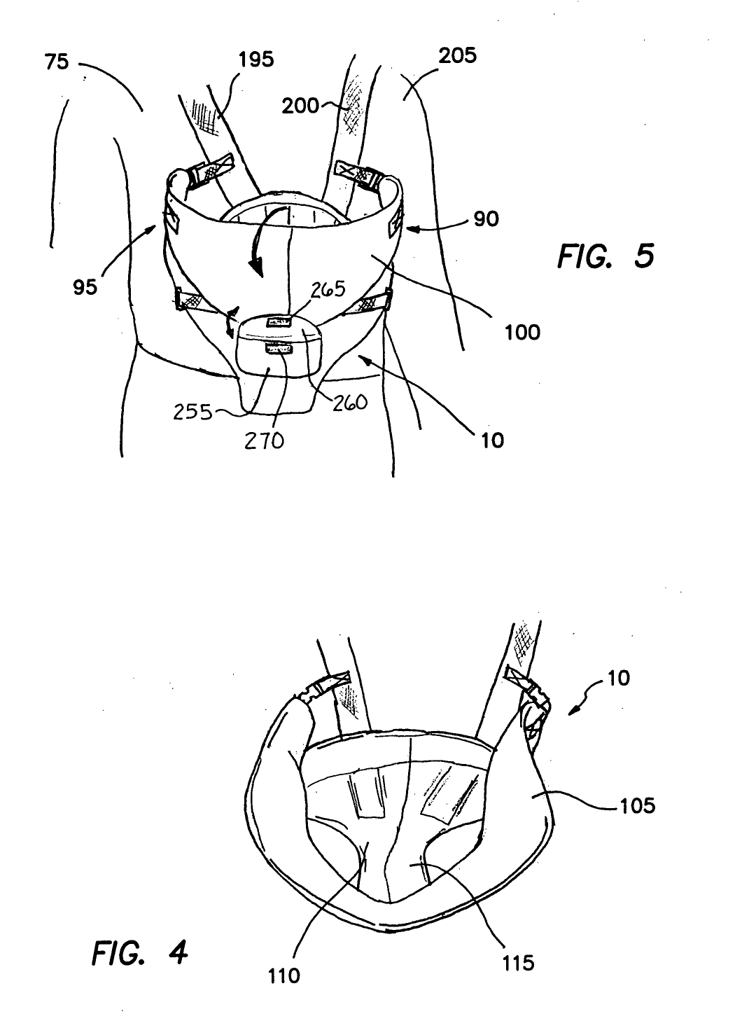

(4) In still a further variant, as illustrated in FIGS. 1 and 2, the front support portion 20 of the support element 15 further includes first 90 and second 95 arm openings. The arm openings 90, 95 are located in an upper section 100 of the front support portion 20 adjacent the first 30 and second 35 side edges of the front portion 20. As illustrated in FIGS. 4 and 5, the upper section 100 is foldable adjacent the first 90 and second 95 arm openings to allow formation of an armrest 105 to accommodate an increase in arm size as an infant grows.

(5) In another variant of the invention, as illustrated in FIG. 4, the front support portion 20 and the rear support portion 25 narrow toward lower ends 110 of the portions 20, 25 to form a crotch support 115 to accommodate legs (not shown) of an infant.

(6) In still another variant, as illustrated in FIGS. 1 and 2, the means 50, 60 for attaching the first 30 and second 35 side edges of the front support portion 20 to the first 40 and second 45 side edges of the rear support portion 25 at at least one point 55, 65 adjacent each of the first 30, 40 and second 35, 45 side edges includes at least one restraining strap 120.

The restraining strap 120 has a first section 125 and a second section 130. The first section 125 is attached to the front support portion 20 at right angles to a long axis 135 of the front support portion 20, and extends outwardly from the first 30 and second 35 side edges of the front support portion 20. The second section 130 is attached to the rear support portion 25 at right angles to a long axis 140 of the rear support portion 25, and extends outwardly from the first 40 and second 45 side edges of the rear support portion 25. First 145 and second 150 adjustable attaching buckle ends are provided. The attaching buckle ends 145, 150 are slidably and adjustably affixed at first 155 and second 160 ends of the second section 130 of the restraining strap 120. First 165 and second 170 receiving buckle ends are provided. The receiving buckle ends 165, 170 are slidably and adjustably affixed at first 175 and second 180 ends of the first section 125 of the restraining strap 120. When the adjustable attaching buckle ends 145, 150 are attached to the receiving buckle ends 165, 170, an opening 177 between the front. support portion 20 and the rear support portion 25 of the support element 15 is adjustable to fit snugly about a torso (not shown) of the infant.

(7) In yet another variant, as illustrated in FIG. 2, the upper section 100 of the front support portion 20 is removably attached to the at least one shoulder strap 70 adjacent the first 30 and second 35 side edges of the front support portion 20 above the first 90 and second 95 arm openings.

(8) In a further variant, as also illustrated in FIG. 2, the upper section 100 of the front support portion 20 is removably and adjustably attached to the at least one shoulder strap 70 with adjustable attaching buckle ends 145. The buckle ends 145 are slidably and adjustably affixed to a second strap section 190 attached to the upper section 100 of the front support portion 20. Receiving buckle ends 165 are affixed to a first strap section 185 attached to the at least one shoulder strap 70.

(9) In another variant of the invention, as illustrated in FIGS. 1, 2 and 5, the at least one shoulder strap 70 includes a first shoulder portion 195. The first shoulder portion 195 is sized and shaped to be worn on the first shoulder 75 of a wearer 80. A second shoulder portion 200 is provided. The second shoulder portion 200 is sized and shaped to be worn on a second shoulder 205 of a wearer 80. As illustrated in FIG. 3, the first 195 and second 200 shoulder portions cross one another at a back 210 of the wearer 80. A sliding fixture 215 is provided. The sliding fixture 215 provides passageways 220 through which the first 195 and second 200 shoulder portions are routed to prevent tangling of the shoulder portions 195, 200.

(10) In still another variant, as illustrated in FIG. 3, the sliding fixture 215 includes a front plate 225 and a rear plate 230. Each of the plates 225, 230 has an inner surface 235 and an outer surface 240. The plates 225, 230 are joined to one another at four points 245 spaced from each other on the inner surfaces 235. The spacing is sufficient to accommodate a width 250 of the first 195 and second 200 shoulder portions. When the shoulder portions 195, 200 of the at least one shoulder strap 70 are threaded through the passageways 220 of the sliding fixture 215, the shoulder portions 195, 200 are easily put over the shoulders 75, 205 of a wearer 80 without tangling.

(11) In yet another variant, as illustrated in FIGS. 1 and 5, a reclosable pocket 255 is provided. The pocket 255 is located upon the front support portion 20 of the support element 15. The pocket 255 is reclosable with a flap 260 of the pocket 255 that has either a hooking element 265 or a looping element 270 attached to it and either a mating hooking element 265 or a mating looping element 270 attached to a front portion 275 of the pocket 255.

(12) In a final variant, as illustrated in FIG. 3, the at least one shoulder strap 70 includes at least one shoulder pad 280. The shoulder pad 280 is slidably attached to the at least one shoulder strap 70.

The front mounted baby carrier 10 has been described with reference to particular embodiments. Other modifications and enhancements can be made without departing from the spirit and scope of the claims that follow.

1. A front mounted baby carrier, comprising:
a support element, said support element having a front support portion and a rear support portion;
said front support portion having a first side edge and a second side edge;
said rear support portion having a first side edge and a second side edge;
means for attaching said first side edge of said front support portion to said first side edge of said rear support portion at at least one point adjacent each of said first side edges;
means for attaching said second side edge of said front support portion to said second side edge of said rear support portion at at least one point adjacent each of said second side edges;
at least one shoulder strap, said shoulder strap attached to said rear support portion; and
whereby, when said shoulder strap is placed over a shoulder of a wearer and an infant is placed between said front support portion and said rear support portion, facing outwardly toward said front support portion, said infant is secured within said carrier on a chest of said wearer by attaching said means for attaching said first side edge of said front support portion to said first side edge of said rear support portion and said means for attaching said second side edge of said front support portion to said second side edge of said rear support portion.

2. A front mounted baby carrier, as described in claim 1, wherein said support element is formed of waterproof material, whereby the carrier is usable in an aqueous environment.

3. A front mounted baby carrier, as described in claim 1, wherein said support element is padded.

4. A front mounted baby carrier, as described in claim 1, wherein said front support portion of said support element further comprises:
first and second arm openings, said arm openings being disposed in an upper section of said front support portion adjacent said first and second side edges of said front portion; and
said upper section being foldable adjacent said first and second arm openings to allow formation of an armrest to accommodate an increase in arm size as an infant grows.

5. A front mounted baby carrier, as described in claim 1, wherein said front support portion and said rear support portion narrow toward lower ends of said portions to form a crotch support to accommodate legs of an infant.

6. A front mounted baby carrier, as described in claim 1, wherein said means for attaching said first and second side edges of said front support portion to said first and second side edges of said rear support portion at at least one point adjacent each of said first and second side edges further comprises:
at least one restraining strap, said restraining strap having a first section and a second section;
said first section being attached to said front support portion orthogonally to a long axis of said front support portion, and extending outwardly from said first and second side edges thereof;
said second section being attached to said rear support portion orthogonally to a long axis of said rear support portion, and extending outwardly from said first and second side edges thereof;
first and second adjustable attaching buckle ends, said attaching buckle ends being slidably and adjustably affixed at first and second ends of said second section of said restraining strap;
first and second receiving buckle ends, said receiving buckle ends being slidably and adjustably affixed at first and second ends of said first section of said restraining strap; and
whereby, when said adjustable attaching buckle ends are attached to said receiving buckle ends, an opening between said front support portion and said rear support portion of said support element is adjustable to fit snugly about a torso of said infant.

7. A front mounted baby carrier, as described in claim 3, wherein said upper section of said front support portion is removably attached to said at least one shoulder strap adjacent said first and second side edges of said front support portion above said first and second arm openings.

8. A front mounted baby carrier, as described in claim 7, wherein said upper section of said front support portion is removably and adjustably attached to said at least one shoulder strap with adjustable attaching buckle ends slidably and adjustably affixed to a second strap section attached to said upper section of said front support portion and receiving buckle ends affixed to a first strap section attached to said at least one shoulder strap.

9. A front mounted baby carrier, as described in claim 1, wherein said at least one shoulder strap further comprises:
a first shoulder portion, said first shoulder portion being sized and shaped to be worn on the first shoulder of a wearer;
a second shoulder portion, said second shoulder portion being sized and shaped to be worn on a second shoulder of a wearer;
said first and second shoulder portions crossing one another at a back of said wearer; and
a sliding fixture, said sliding fixture providing passageways through which said first and second shoulder portions are routed to prevent tangling of said shoulder portions.

10. A front mounted baby carrier, as described in claim 9, wherein said sliding fixture further comprises:
a front plate and a rear plate, each of said plates having an inner surface and an outer surface;
said plates being joined to one another at four points spaced from each other on said inner surfaces, said spacing being sufficient to accommodate a width of said first and second shoulder portions; and
whereby, when said shoulder portions of said at least one shoulder strap are threaded through said passageways of said sliding fixture, said shoulder portions are easily put over the shoulders of a wearer without tangling.

11. A front mounted baby carrier, as described in claim 1, further comprising:
a reclosable pocket, said pocket being disposed upon said front support portion of said support element; and
said pocket being reclosable with a flap of said pocket having either of a hooking element and a looping element attached thereto and either of a mating hooking element and a mating looping element attached to a front portion of said pocket.

12. A front mounted baby carrier, as described in claim 1, wherein said at least one shoulder strap further comprises at least one shoulder pad, said shoulder pad being slidably attached to said at least one shoulder strap.
